(19) United States
(12) Patent Application Publication
(10) Pub. No.: US 2005/0007311 A1
(43) Pub. Date: Jan. 13, 2005

(54) Apparatus and method for driving a plasma display panel

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG Electronics, Inc.

(21) Appl. No.: 10/885,797

(22) Filed: Jul. 8, 2004

(30) Foreign Application Priority Data
Jul. 9, 2003 (KR) 10-2003-0046476

(51) Int. Cl. G09G 3/28

(52) U.S. Cl. 345/60

(57) ABSTRACT

The present invention relates to a plasma display panel, and more particularly, to an apparatus and method for driving of a plasma display panel. In the apparatus for driving of the plasma display panel according to the embodiment of the present invention, the plasma display panel on which a scan electrode, a sustain electrode and an address electrode are formed and which for displaying an image by dividing one frame period into a plurality of subfields, the apparatus comprising a video signal control unit for controlling a voltage of an analog video signal to be inputted in response to a command of user; a video level detection unit for detecting a change in the amplitude and potential of the analog video signal controlled by the video signal control unit; a video signal quantization unit for controlling a quantization level value of the analog video signal controlled by the video signal control unit according to the amplitude and potential change to convert the analog video signal into a digital video signal; and a panel driving circuit for displaying the digital video signal on the plasma display panel.

This Nonprovisional application claims priority under 35 U.S.C. §119(a) on Patent Application No. 10-2003-0046476 filed in Korea on Jul. 09, 2003, the entire contents of which are hereby incorporated by reference.

### BACKGROUND OF THE INVENTION

1. Field of the Invention

The present invention relates to a plasma display panel, and more specifically, to an apparatus and method for driving a plasma display panel.

2. Description of the Background Art

In recent information oriented society, display devices as a visual information transmission media are becoming more important than ever. For the display devices, there occurs a problem in that cathode ray tubes or braun tubes which are now widely used have heavy weight and big volume. It has been developed many kinds of flat panel displays which can overcome this limitation of the cathode ray tubes.

Such a flat panel display device includes a liquid crystal display (LCD), a plasma display panel (PDP), a field emission display (FED), an electro-luminescence (EL) display, etc.

Among these kinds of flat panel display devices, a plasma display panel (hereinafter, referred to as a ‘PDP’) is adapted to display an image or motion picture including characters or graphics by light-emitting the phosphors with ultraviolet rays of 147 nm to be generated during the discharge of gas such as He+Xe, Ne+Xe or He+Xe+Ne. This plasma display panel can be easily made thin and large, and it can provide greatly increased image quality with the help of recent developments of the relevant technologies.

In particular, a three-electrode AC surface discharge type PDP reduce the voltage necessary for a discharge by filling the wall charges using a dielectric layer during discharging. The PDP protects a number of electrodes from sputtering caused by plasma, thereby having advantages of low driving voltage and long-life.

FIG. 1 is a perspective view showing a configuration of discharge cells in a conventional three-electrode AC surface discharge type PDP.

Referring to FIG. 1, discharge cells of a three-electrode AC surface discharge type PDP include a scan electrode Y and a sustain electrode Z which are formed on a bottom surface of an upper substrate 10, and an address electrode X which is formed on a lower substrate 18.

Each of the scan electrode Y and the sustain electrode Z include transparent electrodes 12Y and 12Z, and metal bus electrodes 13Y and 13Z, which have a line width smaller than that of the transparent electrode 12Y, 12Z and formed at each side edges of the transparent electrodes, respectively. As a material of the transparent electrodes 12Y and 12Z, an Indium Tin Oxide (ITO) is generally used. The metal bus electrode 13Y and 13Z are generally made of a metal such as chromium (Cr), and serves to reduce a voltage drop caused by the transparent electrodes 12Y and 12Z having high resistance.

On the bottom surface of the upper substrate 10 in which the scan electrode Y and the sustain electrode Z are placed parallel to each other, an upper dielectric layer 14 and a protective layer 16 is laminated. The upper dielectric layer 14 is accumulated with charged particles (wall charges) generated during gas discharge ionization (plasma) discharging. The protective layer 16 is adapted to protect the upper dielectric layer 14 from sputtering of the charged particles caused during gas discharge ionization (plasma) discharging, and improve the efficiency of secondary electron emissions. As the protective layer 16, magnesium oxide (MgO) is generally used.

The address electrode X is formed in the direction of crossing the scan electrode Y and the sustain electrode Z. On the lower substrate 18 in which the address electrode X is formed, a lower dielectric layer 22 and barrier ribs 24 are formed. A phosphor layer 26 is formed on the surfaces of the lower dielectric layer 22 and the barrier ribs 24.

The barrier ribs 24 are disposed in parallel with the address electrode X, to physically divide the spaces between the discharge cells, thereby preventing ultraviolet rays and visible lights caused during plasma discharging from getting leaked into an adjacent discharge cells. The phosphor layer 26 is excited with an ultraviolet ray generated during the gas discharging to generate any one visible light of red, green and blue lights. A mixed inert gas such as He+Xe, Ne+Xe, He+Xe+Ne or the like is injected into the discharge spaces defined between the upper substrate 1 0 and the barrier ribs 24 and between the lower substrate 1 8 and the barrier ribs 24.

FIG. 2 is a diagram showing a frame configuration according to a driving method of a conventional plasma display panel.

Referring to FIG. 2, this three-electrode AC surface discharge type PDP is driven by dividing one frame into a plurality of subfields having different light-emitting frequencies so as to implement a desirable gray scale of an image. For example, when displaying an image with 256-level gray scale, a period (16.67 ms) of frame that corresponds to 1/60 second is divided into eight subfields. Each of the eight subfields consist of a reset period for bringing about discharge, an address period for selecting a discharge cell, and a sustain period for implementing the gray scale according to the number of discharges. The reset periods and the address periods of each of the subfields have same intervals. But the sustain periods of each of the subfields have increasing intervals in the ratio of 2ⁿ (n=0, 1, 2, 3, 4, 5, 6, 7). Thus, the gray scale is implemented by combination of subfields having different sustain periods.

A method for driving the plasma display panel arranged as described classifies a selective writing (SW) method and a selective erasing (SE) method as to whether the discharge cells selected by the discharge in the address period are light-emitted or not.

In a driving method according to the selective writing (SW) method, entire screen is turned off in the reset period, and then the discharge cells to be sustain-discharged at the sustain period are selectively discharged and turned on in the address period. Next, in the sustain period, an image is displayed by sustain-discharging the selected discharge cells by means of the address discharge in the address period.

In a driving method according to the selective erasing (SE) method, entire screen is turned on by light discharging in the reset period, and then the discharge cells are selectively turned off in the address period. Next, in the sustain period, an image is displayed by sustain-discharging the unselected discharge cells by means of the address discharge in the address period.

The selective erasing (SE) method has a problem that a contrast become lower since the front surface is turned on in a front surface lighting period that is not displayed every frames or subfields. However, because the selective erasing (SE) method use a discharge that remove the wall charge in the cell by the address discharge, it has an advantage that allow the screen to display more bright by reducing the addressing time and enlarging the sustain time due to narrowing the width of an addressing pulse, as compared with the selective writing (SW) method.

The selective writing (SW) method has a problem that can not drive the plasma display panel at a high speed, because the addressing period for selectively being turned on the discharge cells in the address period is longer than that of the selective erasing (SE) method. However, the selective writing (SW) method has an advantage that a contrast is higher than that of the selective erasing (SE) method because in the address period the selective method may selectively turn on the cells to be sustain-discharged at the sustain period.

FIG. 3 is a diagram showing schematically an apparatus of a conventional plasma display panel.

Referring to FIG. 3, a plasma display panel includes a video signal processing unit 30 and a plasma display module (PDP module) 40. The video signal processing unit 30 controls and modulates a video signal inputted from external devices (antenna and video input device), and provides it to the plasma display module. The plasma display module (PDP module) 40 displays an image with the processed video signal to be inputted from the video signal processing unit 30.

The video signal processing unit 30 includes a video signal control unit 32 and a video signal quantization unit 34.

The video signal control unit 32 extracts a video signal from analog signals inputted from the external devices (antenna and video input device) and processes the extracted video signal into video data of red (R), green (G) and blue (B), allowing it to display in the plasma display module. Further, the video signal control unit 32 controls the video signal inputted by user's selection and provides it to the video signal quantization unit 34.

With reference to FIG. 4 and FIG. 5, a control method of video signal inputted in the video signal control unit 32 and representation of gray scale in the plasma display module according to the controlled video signal will be described.

The video signal control unit 32 receives an analog video signal having an amplitude which the maximum value is Vp, as shown in FIG. 4. As a maximum value of a general video signal, the voltage having a range of 0.7 V is applied. The video signal having the amplitude where the maximum value is Vp corresponds to the 256-level gray scale, and is represented with the gray scales from 0 to 255 levels in the plasma display module 40. And each of gray scales represents the corresponding luminance. That is, the maximum value Vp of amplitude is represented with the gray scale of 255 level and the minimum value of amplitude is represented with the gray scale of 0 level.

A conventional plasma display panel permit user to directly control or adjust the image quality. User can control the brightness and contrast of a plasma display panel by means of a signal control device 38 formed on a remote controller or a plasma display panel, as shown in FIG. 5. When user controls the brightness and contrast to be lower by using the signal control device 38, the video signal control unit 32 lowers the amplitude of inputted video signal. That is, the video signal control unit 32 converts Vp as the maximum amplitude value into Vp′, and controls the brightness and contrast of the plasma display panel by using the converted signal. The controlled video signal is provided to the video signal quantization unit 34.

The video signal quantization unit 34 converts the inputted analog video signal of the Vp′ which is controlled in the video signal control unit 32 into a digital signal to be properly adapted to driving of plasma display module 40. That is, the video signal quantization unit 34 quantizes the analog signal into the digital signal and provides it to the plasma display module 40.

The video signal quantization unit 34 converts the inputted analog video signal of Vp′ which is controlled in the video signal control unit 32 into the digital signal, and provides the digital signal which the maximum gray scale value is Br′ to the plasma display module 40.

The plasma display module 40 includes a data driving unit, a scan driving unit, a sustain driving unit, and a timing controller (not shown).

The plasma display module 40 receives a quantized digital video signal which the maximum value of gray scale is Br′ from the video signal quantization unit 34, and provides it to the data driving unit for driving the address electrode X, the scan driving unit for driving the scan electrode Y and the sustain driving unit for driving the sustain electrode Z.

The data driving unit includes a plurality of data drive ICs each connected to the predetermined number of address electrode X, for providing data to the corresponding address electrode X.

The scan driving unit is connected to the scan electrodes Y and simultaneously provides reset pulses (or setup pulses) to the scan electrodes Y. Also, the scan driving unit sequentially provides scan pulses to the scan electrodes Y, and then simultaneously provides sustain pulses to the scan electrodes Y in the sustain period.

The sustain driving unit is commonly connected to the sustain electrodes Z and simultaneously provides the sustain pulses to the sustain electrodes Z.

A timing controller receives vertical and horizontal synchronization signals H and V, and generates a timing control signal. And the timing controller may control a driving timing of the plasma display panel by providing the timing control signal to a data arrangement unit, the data driving unit, the scan driving unit and the sustain driving unit, in correspondence with the drive ICs.

The plasma display module 40 displays an image by driving the video signals inputted from the video signal processing unit 30 by means of the data driving unit, the scan driving unit and the sustain driving unit.

In the conventional plasma display panel described above, when user controls the brightness and contrast of the plasma display panel to be lower, the video signal processing unit 30 converts the analog video signal which the maximum value is Vp into the signal which the maximum value is Vp′, and converts the converted analog signal which the maximum value is Vp′ into the digital video signal which the maximum value of gray scale is Br′, thereby providing the signal to the plasma display module 40.

In this conventional plasma display panel, even when user controls the brightness and contrast, the plasma display module 40 considers the brightness level of the inputted video signal to be lower than that of the maximum value which the maximum value is Vp, because the plasma display panel is provided with the digital video signal of R, G and B. Thus, the gray scale level is maintained to the entire gray scale level Br. Therefore, as shown in FIG. 6, it is not possible to represent a gray scale level beyond the Br′ because the range value ΔQL of each steps of the quantization is set to the same value even though the video signal had been controlled. As the representation of the gray scale is lowered, there is a problem that the image quality of the plasma display panel is deteriorated.

### SUMMARY OF THE INVENTION

Accordingly, an object of the present invention is to solve at least the problems and disadvantages of the background art.

An object of the present invention is to provide an apparatus and method for driving a plasma display panel.

According to an aspect of the present invention, an apparatus, for driving a plasma display panel on which a scan electrode, a sustain electrode and an address electrode are formed and which displays an image by dividing one frame period into a plurality of subfields, comprises: a video signal control unit for controlling a voltage of an analog video signal which is inputted in response to a command of user; a video level detection unit for detecting a change in the amplitude and potential of the analog video signal controlled by the video signal control unit; a video signal quantization unit for controlling a quantization level value of the analog video signal controlled by the video signal control unit according to the amplitude and potential change and converting the analog video signal into a digital video signal; and a panel driving circuit for displaying the digital video signal on the plasma display panel.

According to the aspect of the present invention, a method, for driving a plasma display panel on which a scan electrode, a sustain electrode and an address electrode are formed and which displays an image by dividing one frame period into a plurality of subfields, comprises the steps of: providing a video signal control unit for controlling a voltage value of an analog video signal which is inputted in response to a command of user; controlling a voltage of the inputted analog video signal by the video signal control unit; detecting a change in the amplitude and potential of the analog video signal controlled by a video level detection unit; controlling a quantization level value of the analog video signal controlled according to the amplitude and potential change through a video signal quantization unit; converting the controlled analog video signal into a digital video signal on the basis of the quantization level value controlled by the video signal quantization unit; providing a driving circuit for driving the plasma display panel; and displaying the digital video signal on the plasma display panel through the driving circuit.

The apparatus and method, for driving a plasma display panel of the present invention, can improve an image quality by representing the full gray scale of the original video signal even when the controlled analog video signal is converted into the digital video signal.

### BRIEF DESCRIPTION OF THE DRAWINGS

The invention will be described in detail with reference to the following drawings in which like numerals refer to like elements.

FIG. 1 is a perspective view showing the configuration of a discharge cell of a conventional three-electrode AC surface discharge type plasma display panel.

FIG. 2 is a diagram showing the frame configuration according to a method for driving of a conventional plasma display panel.

FIG. 3 is a schematic diagram showing an apparatus for driving of a conventional plasma display panel.

FIG. 4 is a diagram showing a method for controlling of a video signal of a conventional plasma display panel.

FIG. 5 is a diagram showing a gray scale representation according to the controlled video signal of a conventional plasma display panel.

FIG. 6 is a diagram showing a representation of gray scale of the quantized video signal according to the controlled video signal.

FIG. 7 is a perspective view showing the configuration of a discharge cell of a three-electrode AC surface discharge type plasma display panel according to the embodiment of the present invention.

FIG. 8 is a diagram showing a frame configuration according to a method for driving of the plasma display panel according to the embodiment of the present invention.

FIG. 9 is a diagram showing an apparatus for driving of the plasma display panel according to the embodiment of the present invention.

FIG. 10 and FIG. 11 are diagrams showing a method for controlling the video signal of the plasma display panel according to the embodiment of the present invention.

FIG. 12 is a diagram showing a method for quantizing the controlled video signal according to the embodiment of the present invention.

FIG. 13 is a diagram a gray scale representation according to the controlled video signal according to the embodiment of the present invention.

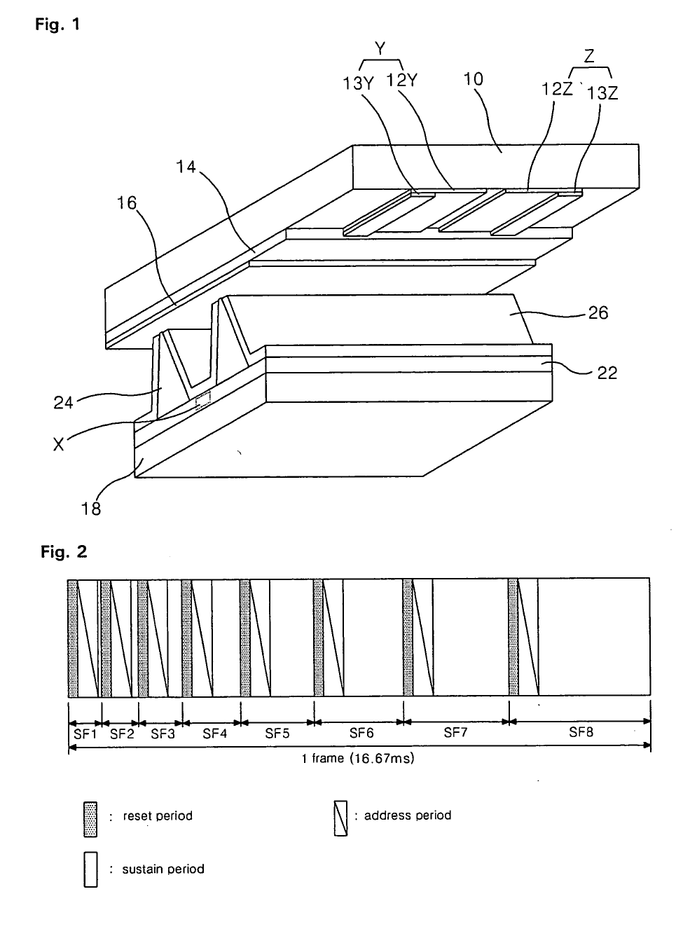

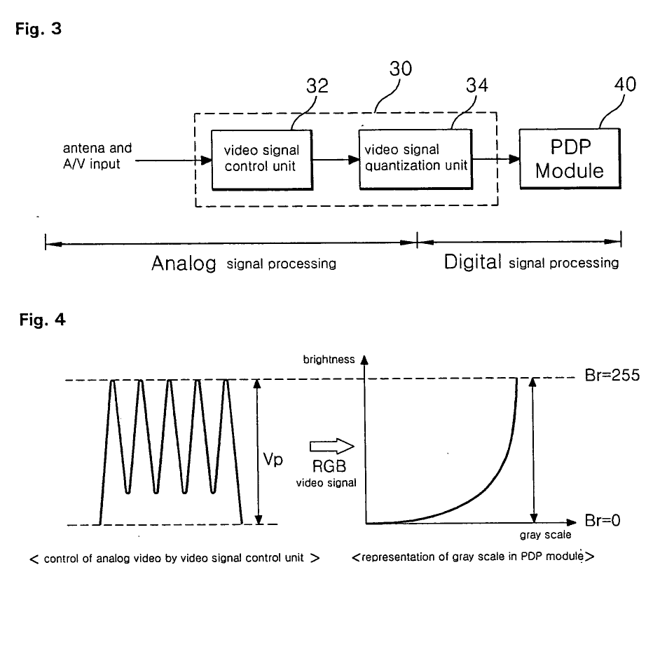

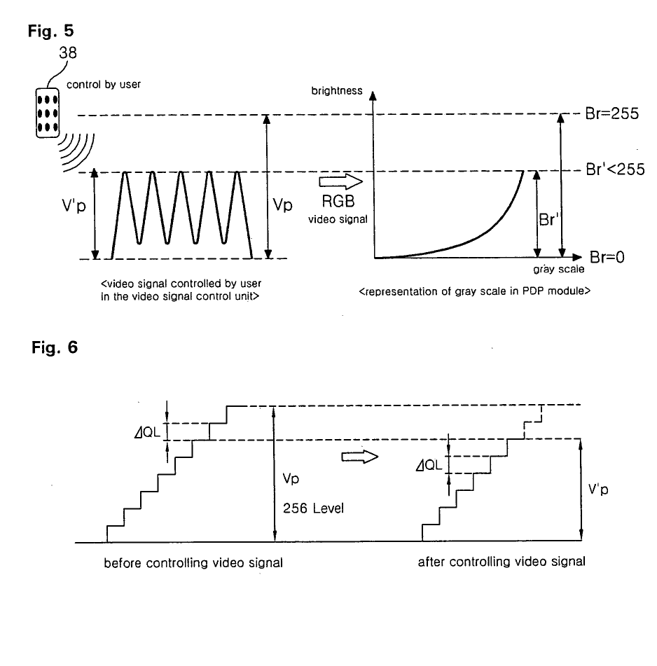

### DETAILED DESCRIPTION OF PREFERRED EMBODIMENTS

Preferred embodiments of the present invention will be described in a more detailed manner with reference to the drawings.

According to an embodiment of the present invention, an apparatus, for driving a plasma display panel on which a scan electrode, a sustain electrode and an address electrode are formed and which displays an image by dividing one frame period into a plurality of subfields, comprises: a video signal control unit for controlling a voltage of an analog video signal which is inputted in response to a command of user; a video level detection unit for detecting a change in the amplitude and potential of the analog video signal controlled by the video signal control unit; a video signal quantization unit for controlling a quantization level value of the analog video signal controlled by the video signal control unit according to the amplitude and potential change and converting the analog video signal into a digital video signal; and a panel driving circuit for displaying the digital video signal on the plasma display panel.

In the apparatus for driving the plasma display panel according to the embodiment of the present invention, the driving circuit further includes: a scan driving unit for driving the scan electrode; a sustain driving unit for driving the sustain electrode; a data driving unit for driving the address electrode; and a image quality control unit for controlling the sustain driving unit according to the amplitude and potential change detected by the video level detection unit.

In the apparatus for driving a plasma display panel according to the embodiment of the present invention, the sustain driving unit controls the number of sustain pulses generated from the sustain electrode under the control of the image quality control unit.

In the apparatus for driving a plasma display panel according to the embodiment of the present invention, the video signal quantization unit changes the quantization level value according to the amplitude and potential change of the controlled analog video signal.

In the apparatus for driving a plasma display panel according to the embodiment of the present invention, the video signal quantization unit converts a peak voltage of the controlled analog video signal into a peak value of the digital video signal.

In the apparatus for driving a plasma display panel according to the embodiment of the present invention, the video signal quantization unit converts a minimum voltage of the controlled analog video signal into a minimum value of the digital video signal.

In the apparatus for driving a plasma display panel according to the embodiment of the present invention, the image quality control unit controls the sustain driving unit so that the number of the sustain pulses applied to the sustain electrode can be reduced, as the peak voltage of the controlled analog video signal is lowered.

According to the aspect of the present invention, a method, for driving a plasma display panel on which a scan electrode, a sustain electrode and an address electrode are formed and which displays an image by dividing one frame period into a plurality of subfields, comprises the steps of: providing a video signal control unit for controlling a voltage value of an analog video signal which is inputted in response to a command of user; controlling a voltage of the inputted analog video signal by the video signal control unit; detecting a change in the amplitude and potential of the analog video signal controlled by a video level detection unit; controlling a quantization level value of the analog video signal controlled according to the amplitude and potential change through a video signal quantization unit; converting the controlled analog video signal into a digital video signal on the basis of the quantization level value controlled by the video signal quantization unit; providing a driving circuit for driving the plasma display panel; and displaying the digital video signal on the plasma display panel through the driving circuit.

In the method for driving a plasma display panel according to the embodiment of the present invention, the method further includes the steps of: driving the scan electrode by a scan driving unit; driving the sustain electrode by a sustain driving unit; driving the address electrode by a data driving unit; and controlling the sustain driving unit according to the amplitude and potential change the video signal detected in the video level detection unit by a image quality control unit.

In the method for driving a plasma display panel according to the embodiment of the present invention, the sustain driving unit controls the number of sustain pulses generated from the sustain electrode under the control of the image quality control unit.

In the method for driving a plasma display panel according to the embodiment of the present invention, the video signal quantization unit changes the quantization level value according to the amplitude and potential change of the controlled analog video signal.

In the method for driving a plasma display panel according to the embodiment of the present invention, the video signal quantization unit converts a peak voltage of the controlled analog video signal into a peak value of the digital video signal.

In the method for driving a plasma display panel according to the embodiment of the present invention, the video signal quantization unit converts a minimum voltage of the controlled analog video signal into a minimum value of the digital video signal.

In the method for driving a plasma display panel according to the embodiment of the present invention, the image quality control unit controls the sustain driving unit so that the number of the sustain pulses applied to the sustain electrode can be reduced, as the peak voltage of the controlled analog video signal is lowered.

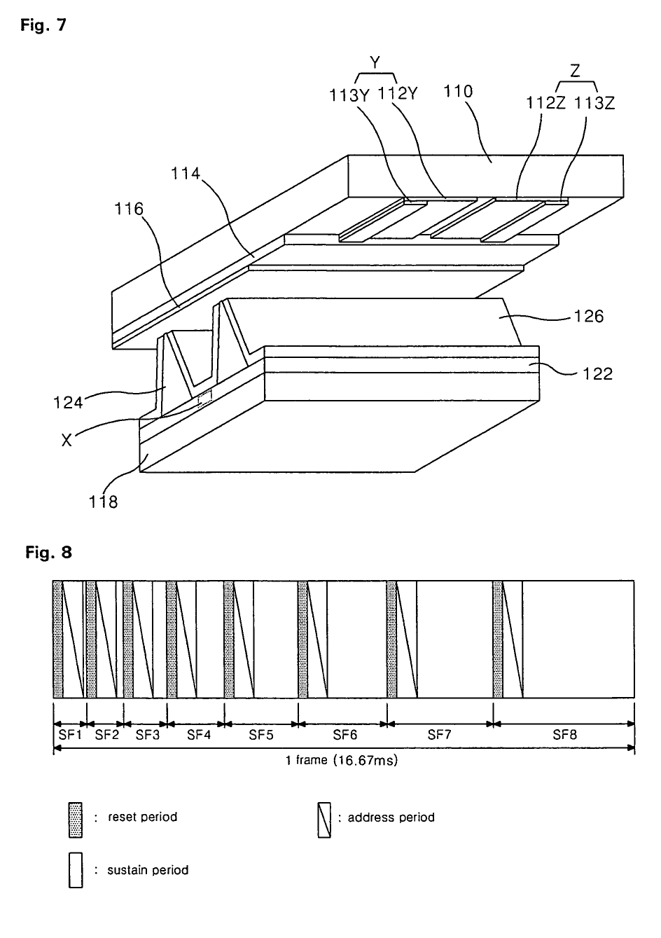

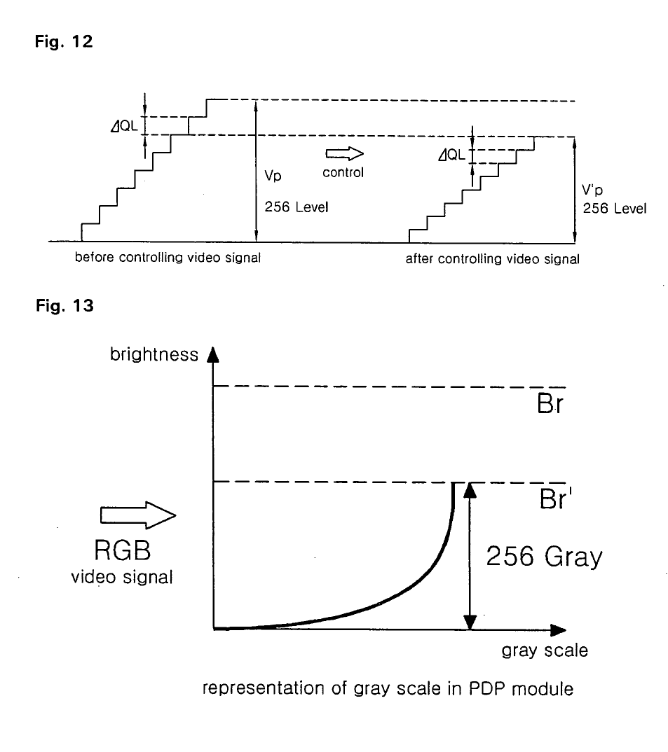

Hereinafter, a plasma display panel according to the present invention will be described in further detail with reference to the accompanying drawings, FIG. 7 to FIG. 13.

FIG. 7 is a perspective view showing the configuration of a discharge cell of the three-electrode AC surface discharge type PDP according to the embodiment of the present invention.

Referring to FIG. 7, the discharge cells of the three-electrode AC surface discharge type PDP include a scan electrode Y and a sustain electrode Z which are formed on a bottom surface of an upper substrate 110, an address electrode X which is formed on a lower substrate 118.

Each of the scan electrode Y and the sustain electrode Z include transparent electrodes 112Y and 112Z, and metal bus electrodes 113Y and 113Z, which have a line width smaller than that of the transparent electrode 112Y and 112Z and formed at each side edges of the transparent electrodes, respectively. As a material of the transparent electrodes 112Y and 112Z, an Indium Tin Oxide (ITO) is used. The metal bus electrode 113Y and 113Z are generally made of a metal such as chromium (Cr), and serves to reduce a voltage drop caused by the transparent electrodes 112Y and 112Z having high resistance.

On the bottom surface of the upper substrate 110 in which the scan electrode Y and the sustain electrode Z are placed parallel to each other, an upper dielectric layer 114 and a protective layer 116 are laminated. The upper dielectric layer 114 is accumulated with charged particles (wall charges) generated during gas discharge ionization (plasma) discharging. The protective layer 116 is adapted to protect the upper dielectric layer 114 from sputtering of the charged particles caused during gas discharge ionization (plasma) discharging, and improve the efficiency of secondary electron emissions. As the protective layer 116, magnesium oxide (MgO) is generally used.

The address electrode X is formed in the direction of crossing the scan electrode Y and the sustain electrode Z. On the lower substrate 118 in which the address electrode X is formed, a lower dielectric layer 122 and barrier ribs 124 are formed. A phosphor layer 126 is formed on the lower dielectric layer 122 and the barrier ribs 124.

The barrier ribs 124 are disposed in parallel with the address electrode X, to physically divide the spaces between the discharge cells, thereby preventing ultraviolet rays and visible lights caused during plasma discharging from getting leaked into an adjacent discharge cells. The phosphor layer 126 is excited with an ultraviolet ray generated during the gas discharging to generate any one visible light of red, green and blue lights. A mixed inert gas such as He+Xe, Ne+Xe, He+Xe+Ne or the like is injected into the discharge spaces defined between the upper substrate 110 and the barrier ribs 124 and between the lower substrate 118 and the barrier ribs 124.

FIG. 8 is a diagram showing a frame configuration according to a method for driving of the plasma display panel according to the embodiment of the present invention.

Referring to FIG. 8, the three-electrode AC surface discharge type PDP according to the embodiment of the present invention is driven by dividing one frame into a plurality of subfields having different light-emitting frequencies so as to implement a gray scale of image. For example, when displaying an image with 256-level gray scale, a period (16.67 ms) of frame that corresponds to 1/60 second is divided into eight subfields. Each of the eight subfields consists of a reset period for bringing about discharge uniformly, an address period for selecting a discharge cell, and a sustain period for implementing the gray scale according to the number of discharges. The reset periods and the address periods of each of the subfields have same intervals. But the sustain periods of each of the sub-fields have increasing intervals in the ratio of 2ⁿ (n=0, 1, 2, 3, 4, 5, 6, 7). Thus, the gray scale is implemented by combination of subfields having different sustain periods.

The method for driving the plasma display panel arranged as described includes a selective writing (SW) method and a selective erasing (SE) method which are classified as to whether discharge cells selected by the discharge in the address period are light-emitted or not.

In a driving method according to the selective writing (SW) method, the entire screen is turned off in the reset period, and then the discharge cells to be sustain-discharged at the sustain period is selectively discharged and turned on in the address period. Next, In the sustain period, an image is displayed by sustain-discharging the selected discharge cells by means of the address discharge in the address period.

In a driving method according to the selective erasing (SE) method, the entire screen is turned on by light discharging in the reset period, and then the discharge cells are selectively turned off in the address period. Next, In the sustain period, an image is displayed by sustain-discharging the unselected discharge cells by means of the address discharge in the address period.

The selective erasing (SE) method has a problem that a contrast become lower since the front surface is turned on in a front surface lighting period that is not displayed every frames or subfields. However, because the selective erasing (SE) method use a discharge that remove the wall charge in the cell by the address discharge, it has an advantage that allow the screen to display more bright by reducing the addressing time and enlarging the sustain time due to narrowing the with of an addressing pulse, as compared with the selective writing (SW) method.

The selective writing (SW) method has a problem that can not drive the plasma display panel at a high speed, because the addressing period to selectively be turned on the discharge cells in the address period is longer than that of the selective erasing (SE) method. However, the selective writing (SW) method has an advantage that a contrast is higher than that of the selective erasing (SE) method because in the address period the selective method may selectively turn on the cells to be sustain-discharged at the sustain period.

In recent days, in order to employ the advantages of the selective writing (SW) method and the selective erasing (SE) method, among a plurality of subfields comprising one frame, one portion of the subfields employs the selective writing (SW) method and remaining portion of the subfields employs the selective erasing (SE) method. Thus one frame employs a selective writing and erasing (SWSE) method.

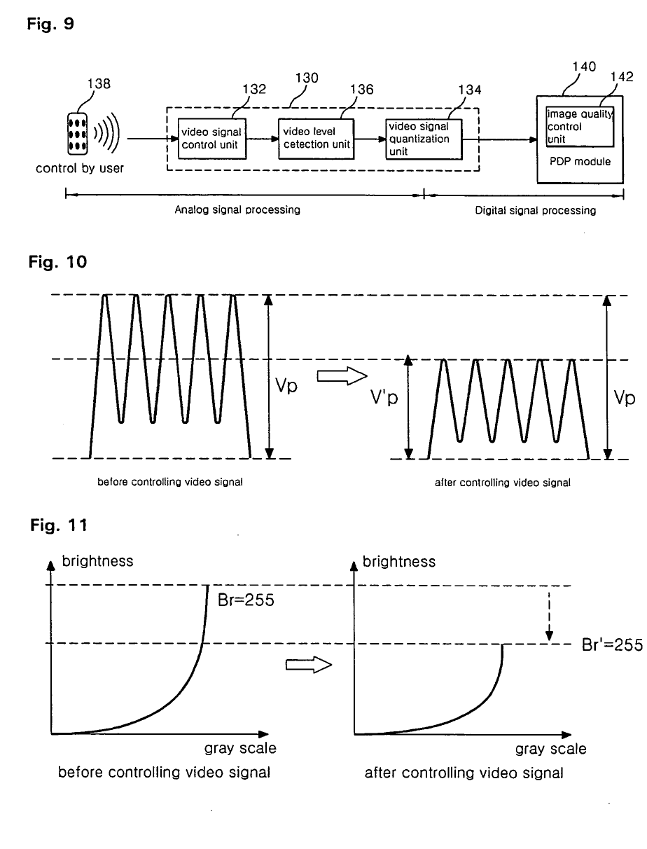

FIG. 9 is a diagram showing an apparatus for driving of the plasma display panel according to the embodiment of the present invention.

Referring to FIG. 9, a plasma display panel according to the embodiment of the present invention includes a video signal processing unit 130 and a plasma display module (PDP module) 140. The video signal processing unit 130 controls and modulates a video signal inputted from external devices (antenna and video input device), and provides it to the plasma display module. The plasma display module (PDP module) 140 displays an image with the processed video signal inputted from the video signal processing-unit 130.

The video signal processing unit 130 includes a video signal control unit 132, a video level detection unit 136 and a video signal quantization unit 134. The plasma display module 140 includes an image quality control unit 142.

The video signal control unit 132 extracts a video signal from analog signals inputted from the external devices (antenna and video input device) and processes the extracted video signal into video data of red (R), green (G) and blue (B), allowing it to display in the plasma display module. Further, the video signal control unit 132 controls the analog video signal inputted by user's selection inputted through the signal control unit 138 and provides it to the video level detection unit 136.

The video level detection unit 136 detects the amplitude and potential change values including the maximum (peak) value and minimum value of the analog video signal controlled in response to the user's selection, and provides the analog video signal and the amplitude and potential change values of the detected analog video signal to the video signal quantization unit 134.

With reference to FIG. 10 and FIG. 11, a control method of video signal inputted in the video signal control unit 132 and the representation of gray scale in the plasma display module according to the controlled video signal will be described.

The video signal control unit 132 receives an analog video signal having an amplitude which the maximum value is Vp, as shown in FIG. 10. As a maximum value of a general video signal, the voltage with the range of 0.7 V is applied. When an analog video signal is converted into a digital video signal by sampling with 8 bits, the video signal having the amplitude which the maximum value is Vp corresponds to the 256-level gray scale in the plasma display module 140, and is represented with the gray scale from 0 to 255 levels. And each of gray scales represents the corresponding luminance. That is, the maximum value Vp of the amplitude is represented with the gray scale of 255 level and the minimum value of the amplitude is represented with the gray scale of 0 level.

The plasma display panel according to the embodiment of the present invention permits user to directly control the image quality. User can control brightness and contrast of the plasma display panel by means of a signal control device 138 formed on a remote controller or a plasma display panel, as shown in FIG. 9. When user controls brightness and contrast to be low by using the signal control device 138, the video signal control unit 132 lowers the amplitude of inputted video signal. That is, the video signal control unit 132 converts the maximum amplitude value of Vp into Vp′, and controls the brightness and contrast of the plasma display panel by using the converted signal Vp′, as shown in FIG. 11. The video level detection unit 136 detects the amplitude and potential change values including the maximum (peak) value and minimum value of the video signal from the controlled analog video signal, provides the video signal and the amplitude and potential change values of the detected video signal to the video signal quantization unit 134.

The video signal quantization unit 134 converts the analog signal which the maximum value of signal controlled and inputted from the video signal control unit 132 is Vp′ into the digital signal to be adapted to the plasma display panel (PDP module) 40. That is, the video signal quantization unit 134 quantizes the analog signal into the digital signal and provides the quantized video signal to the plasma display module 140.

The quantization means that an analog signal is converted into a digital signal. Specifically, it means that successive signals are divided into prescribed time units, signal magnitudes in each of the time units are discretely stepping in response to the prescribe number of steps.

The video signal quantization unit 134 converts the analog video signal which the maximum value adjusted and inputted in the video signal control unit 132 is Vp′ into the digital video signal which the maximum gray scale is Br′, and provides the digital video signal to the plasma display panel 140.

The video signal quantization unit 134 converts the analog video signal whose amplitude is reduced when the video signal controlled by user is quantized, into the digital video signal. Also, the video signal quantization unit 134 controls the maximum value of the analog signal detected from the video level detection unit 136 into the maximum value of the gray scale value of the digital video signal, by reducing the quantization level value ΔQL of the digital video signal to be adaptable to the amplitude and potential change values of the analog video signal. Furthermore, the video signal quantization unit 134 controls the minimum value of the video signal into the minimum value the digital video signal.

With this method, it is possible to represent the full gray scale of the original video signal in the plasma display panel, even when the controlled analog video signal is converted into the digital video signal.

The video signal quantization unit 134 provides the amplitude and potential change values of the signal including the maximum value and the minimum value of the video signal detected from the video signal level detection unit 136 to the image quality control unit 142 in the plasma display module 140.

The plasma display module 140 includes an image quality control unit 142, a data driving unit (not shown), a scan driving unit, a sustain driving unit, and a timing controller.

The image quality control unit 142 controls the maximum value and the minimum value supplied to the sustain electrode so that the maximum value of the video signal detected from the video signal level detection unit 136 may be suitable for the gray level of the video signal provided to a sustain providing unit and adjusted in it.

The plasma display module 140 receives a digital video signal which maximum value of the quantized gray scale is Br′, and provides the video signal to the data driving unit, the scan driving unit, and the sustain driving unit for driving the address electrode X, the scan electrode Y, and the sustain electrode Z, respectively.

The data driving unit includes a plurality of data drive ICs which is respectively connected to a predetermined number of address electrode X and provides data to a corresponding address electrode X.

The scan driving unit is connected to the scan electrodes Y, and simultaneously provides reset pulses (or setup pulses) to the scan electrodes Y. Also, the scan driving unit simultaneously provides scan pulses to the scan electrodes Y in the address period, and then simultaneously provides sustain pulses to the scan electrodes Y in the sustain period.

The sustain driving unit is commonly connected to the sustain electrodes Z and simultaneously provides the sustain pulses to the sustain electrodes Z. In addition, the sustain driving unit receives the maximum and minimum value of the controlled video signal from the image quality control unit 142, and adjusts the number of the sustain pulses applied to the sustain electrode to be suitable for the maximum and minimum value of the video signal, thereby controlling the brightness of the plasma display panel.

A timing controller receives vertical and horizontal synchronization signals H and V, and generates a timing control signal. And the timing controller may control a driving timing of the plasma display panel by providing the timing control signal to a data arrangement unit, the data driving unit, the scan driving unit and the sustain driving unit, in correspondence with the drive ICs.

The plasma display module 140 according to the embodiment of the present invention displays an image by driving the digital video signals inputted from the video signal processing unit 130 by means of the data driving unit, the scan driving unit and the sustain driving unit, and by controlling the brightness and contrast to be suitable for the video signal adjusted by user. Furthermore, it is possible to improve an image quality by representing the full gray scale of the original video signal even when the controlled analog video signal is converted into the digital video signal.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for driving a plasma display panel on which a scan electrode, a sustain electrode and an address electrode are formed and which displays an image by dividing one frame period into a plurality of subfields, the apparatus comprising:
a video signal control unit for controlling a voltage of an analog video signal which is inputted in response to a command of user;
a video level detection unit for detecting a change in the amplitude and potential of the analog video signal controlled by the video signal control unit;
a video signal quantization unit for controlling a quantization level value of the analog video signal controlled by the video signal control unit according to the amplitude and potential change and converting the analog video signal into a digital video signal; and
a panel driving circuit for displaying the digital video signal on the plasma display panel.

2. The apparatus of claim 1, wherein the driving circuit further comprising: a scan driving unit for driving the scan electrode; a sustain driving unit for driving the sustain electrode; a data driving unit for driving the address electrode; and a image quality control unit for controlling the sustain driving unit according to a change in the amplitude and potential detected by the video level detection unit.

3. The apparatus of claim 2, wherein the sustain driving unit controls the number of sustain pulses generated from the sustain electrode under the control of the image quality control unit.

4. The apparatus of claim 1, wherein the video signal quantization unit changes the quantization level value according to a change in the amplitude and potential of the controlled analog video signal.

5. The apparatus of claim 4, wherein the video signal quantization unit converts a peak voltage of the controlled analog video signal into a peak value of the digital video signal.

6. The apparatus of claim 4, wherein the video signal quantization unit converts a minimum voltage of the controlled analog video signal into a minimum value of the digital video signal.

7. The apparatus of claim 2, wherein the image quality control unit controls the sustain driving unit so that the number of the sustain pulses applied to the sustain electrode can be reduced, as the peak voltage of the controlled analog video signal is lowered.

8. A method for driving a plasma display panel on which a scan electrode, a sustain electrode and an address electrode are formed and which displays an image by dividing one frame period into a plurality of subfields, the method comprising the steps of:
providing a video signal control unit for controlling a voltage value of an analog video signal which is inputted in response to a command of user;
controlling a voltage of the inputted analog video signal by the video signal control unit;
detecting a change in the amplitude and potential of the analog video signal controlled by a video level detection unit;
controlling a quantization level value of the analog video signal controlled according to the amplitude and potential change through a video signal quantization unit;
converting the controlled analog video signal into a digital video signal on the basis of the quantization level value controlled by the video signal quantization unit;
providing a driving circuit for driving the plasma display panel; and
displaying the digital video signal on the plasma display panel through the driving circuit.

9. The method of claim 8, further comprising the steps of: driving the scan electrode by a scan driving unit; driving the sustain electrode by a sustain driving unit; driving the address electrode by a data driving unit; and controlling the sustain driving unit according to a change in the amplitude and potential of the video signal detected in the video level detection unit by a image quality control unit.

10. The method of claim 9, wherein the sustain driving unit controls the number of sustain pulses generated from the sustain electrode under the control of the image quality control unit.

11. The method of claim 8, wherein the video signal quantization unit changes the quantization level value according to the amplitude and potential change of the controlled analog video signal.

12. The method of claim 11, wherein the video signal quantization unit converts a peak voltage of the controlled analog video signal into a peak value of the digital video signal.

13. The method of claim 11, the video signal quantization unit converts a minimum voltage of the controlled analog video signal into a minimum value of the digital video signal.

14. The method of claim 9, the image quality control unit controls the sustain driving unit so that the number of the sustain pulses applied to the sustain electrode can be reduced, as the peak voltage of the controlled analog video signal is lowered.
